(19) United States
(12) Patent Application Publication
(10) Pub. No.: US 2008/0266670 A1
(43) Pub. Date: Oct. 30, 2008

(54) FIXED-FOCUS LENS SYSTEM

(75) Inventor: Chen-cheng Liao, Tantz Shiang (TW)

Correspondence Address: MADSON & AUSTIN, 15 WEST SOUTH TEMPLE, SUITE 900, SALT LAKE CITY, UT, 84101, US

(73) Assignee: Asia Optical Co., Inc, Tantz Shiang (TW)

(21) Appl. No.: 12/105,908

(22) Filed: Apr. 18, 2008

(30) Foreign Application Priority Data
Apr. 26, 2007 (TW) 096114849

(51) Int. Cl. G02B 3/04; G02B 3/10

(52) U.S. Cl. 359/654

(57) ABSTRACT

A fixed-focus lens system includes, in order from an object side to an image side along an optical axis thereof, an aperture stop, a first positive lens, a second negative lens, a third positive meniscus lens, and a fourth negative lens having increasing negative refractive power from the optical axis toward the periphery. The fixed-focus lens system satisfies the following condition: 0.1<R_{S32}/f<0.3, where f is the effective focal length of the fixed-focus lens system, and R_{S32} is the curvature radius of an image-side surface of the third positive meniscus lens.

### BACKGROUND OF THE INVENTION

1. Field of the Invention

The present invention relates to a lens system, and particularly to a fixed-focus lens system.

2. Description of Prior Art

In recent years, with the rapid development of digital cameras, the resolution of an image sensor of the digital camera has also been increasing. Correspondingly, the optimal design of an optical lens system in the digital camera has become more and more important. In general, camera lens systems can be classified into fixed-focus lens systems having fixed focal lengths and zoom lens systems with variable focal lengths. A fixed-focus lens system has a relatively simple configuration and thus can be manufactured at a low cost while ensuring a high image quality.

Although the fixed-focus lens system has been developed for a long time, some problems still occur with the increase of the resolution of the image sensor. The main problem is that it is difficult to obtain a balance between the image circle, the imaging ratio and the overall length of the fixed-focus lens system. Accordingly, there still remains room for developing a fixed-focus lens system that can meet various requirements.

When compactness and low-cost are both required for a high resolution camera device employing a fixed-focus lens system, how to reduce the production cost and the overall length of the fixed-focus lens system while ensuring a high-resolution image quality and a sufficient image height becomes a problem encountered by lens manufactures.

### SUMMARY OF THE INVENTION

The object of the present invention is to provide a fixed-focus lens system that offers high image quality and sufficient image height with reduced production cost and reduced overall length.

To achieve the above object of the present invention, a fixed-focus lens system in accordance with the present invention comprises a positive collecting lens for collecting light from an object to be imaged, a positive meniscus lens, first and second negative lenses and an aperture stop. The positive meniscus lens is disposed on an image side of the positive collecting lens, and has a concave surface on an object side and a convex surface on the image side. The positive meniscus lens has at least one aspheric surface. The first negative lens is disposed between the positive collecting lens and the positive meniscus lens, and has a concave image-side surface and an object-side surface with positive or negative curvature. The first negative lens also has at least one aspheric surface. The second negative lens is disposed on the image side of the positive meniscus lens, and has increasingly negative refractive power from the optical axis toward the periphery. The aperture stop is disposed on the object side of the positive collecting lens. The fixed-focus lens system satisfies the following condition: 0.1<R_{S32}/f<0.3, where f represents the effective focal length of the fixed-focus lens system, and R_{S32} represents the curvature radius of the image-side surface of the positive meniscus lens.

According to a preferred embodiment of the present invention, the fixed-focus lens system comprises, in order from an object side to an image side along an optical axis thereof, an aperture stop, a first positive lens, a second negative lens, a third positive meniscus lens and a fourth negative lens. The fourth negative lens has increasingly negative refractive power from an optical axis toward a periphery. Further, the fixed-focus lens system of the present invention satisfies the following condition: 0.1<R_{S32}/f<0.3, where f represents the effective focal length of the fixed-focus lens system, and R_{S32} represents the curvature radius of the image-side surface of the third positive meniscus lens. Preferably, the second negative lens, the third positive meniscus lens and the fourth negative lens are made of plastic.

The fixed-focus lens system of the present invention has an effective focal length that is controlled to reduce the overall length of the lens system and to provide high image quality and sufficient image height. In addition, the ease of manufacture can be enhanced by making the majority of component lenses of the lens system to be plastic and aspheric lenses. Thus, the fixed-focus lens system of the present invention can be manufactured at a low cost while providing a high image quality.

### BRIEF DESCRIPTION OF THE DRAWINGS

The present invention may best be understood through the following description with reference to the accompanying drawings, in which:

FIG. 1 is a representative view showing the configuration of a fixed-focus lens system in accordance with the present invention;

FIG. 2 is a graph showing longitudinal spherical aberration of Numerical Embodiment 1 of the fixed-focus lens system in accordance with the present invention;

FIG. 3 is a graph showing lateral chromatic aberration of Numerical Embodiment 1 of the fixed-focus lens system in accordance with the present invention;

FIG. 4A is a graph showing field curvature of Numerical Embodiment 1 of the fixed-focus lens system in accordance with the present invention;

FIG. 4B is a graph showing distortion of Numerical Embodiment 1 of the fixed-focus lens system in accordance with the present invention;

FIG. 5 is a graph showing longitudinal spherical aberration of Numerical Embodiment 2 of the fixed-focus lens system in accordance with the present invention;

FIG. 6 is a graph showing lateral chromatic aberration of Numerical Embodiment 2 of the fixed-focus lens system in accordance with the present invention;

FIG. 7A is a graph showing field curvature of Numerical Embodiment 2 of the fixed-focus lens system in accordance with the present invention;

FIG. 7B is a graph showing distortion of Numerical Embodiment 2 of the fixed-focus lens system in accordance with the present invention;

FIG. 8 is a graph showing longitudinal spherical aberration of Numerical Embodiment 3 of the fixed-focus lens system in accordance with the present invention;

FIG. 9 is a graph showing lateral chromatic aberration of Numerical Embodiment 3 of the fixed-focus lens system in accordance with the present invention;

FIG. 10A is a graph showing field curvature of Numerical Embodiment 3 of the fixed-focus lens system in accordance with the present invention; and

FIG. 10B is a graph showing distortion of Numerical Embodiment 3 of the fixed-focus lens system in accordance with the present invention.

### DETAILED DESCRIPTION OF THE PREFERRED EMBODIMENTS

In a preferred embodiment of the present invention, the majority of component lenses or constituent lenses of the fixed-focus lens system in accordance with the present invention are plastic aspheric lenses. This significantly reduces the tolerance sensitivity during manufacture, and thus reduces the production cost of the fixed-focus lens system of the present invention while ensuring high image quality. The effective focal length of the fixed-focus lens system of the present invention is also controlled so as to meet the requirements concerning the overall length and the image height of the present lens system. It is evident to those skilled in the art that various alternations and modifications may be made without departing from the inventive concept and scope of the present invention. These alternations and modifications include, for example, changes to optical parameters of the present lens system and the material of component lenses according to the actual application.

The fixed-focus lens system in accordance with the present invention comprises a positive collecting lens, a positive meniscus lens, first and second negative lenses and an aperture stop. The positive meniscus lens is disposed on the image side of the positive collecting lens, and has a concave surface on the object side and a convex surface on the image side. The positive meniscus lens has at least one aspheric surface. The first negative lens is disposed between the positive collecting lens and the positive meniscus lens, and has a concave image-side surface and an object-side surface with positive or negative curvature. The first negative lens also has at least one aspheric surface.

The second negative lens is disposed on the image side of the positive meniscus lens, and has increasingly negative refractive power from the optical axis toward the periphery. The second negative lens has at least one aspheric surface formed with an inflection point. The aperture stop is disposed on the object side of the positive collecting lens.

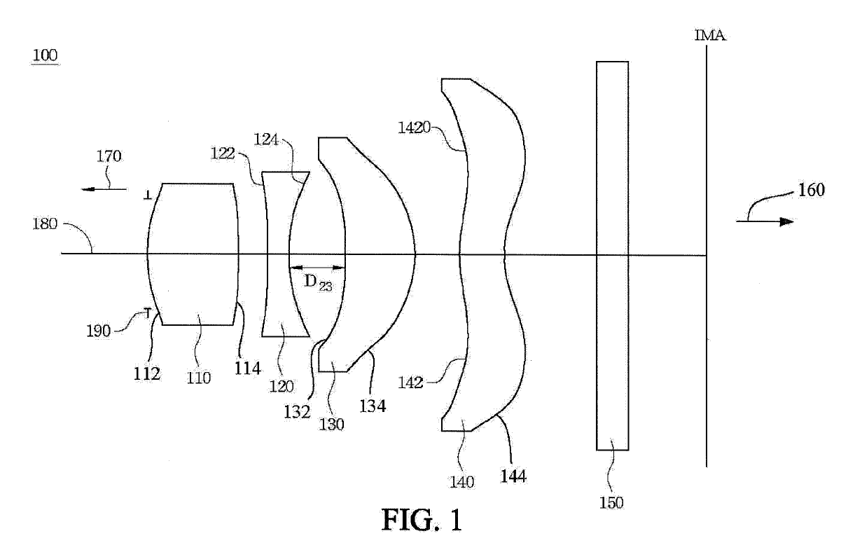

Referring to FIG. 1, a clear explanation of the spatial relationships and functions of the component lenses of the fixed-focus lens system of the present invention will be given. FIG. 1 representatively shows the configuration of a fixed-focus lens system 100 in accordance with the present invention. To facilitate understanding, the component lenses of the fixed-focus lens system 100 will be described hereinafter, in order from an object side 170 to an image side 160. When the fixed-focus lens system 100 is assembled to a camera device, the image side 160 corresponds to the side of an image sensor of the camera device.

The fixed-focus lens system 100 includes, in order from the object side 170 to the image side 160 along an optical axis 180 thereof, an aperture stop 190, a first positive lens 110, a second negative lens 120, a third positive meniscus lens 130 and a fourth negative lens 140, wherein the first positive lens 110 functions as a collecting lens for collecting light from an object to be imaged.

The first positive lens 110 has the highest refractive power in the fixed-focus lens system 100. The first positive lens 110 has a first convex surface 112 on the object side 170 and a second convex surface 114 on the image side 160. The second negative lens 120 has an object-side surface 122 with positive or negative curvature and an image-side surface 124 concave toward the object side 170 to increase the image height and to perform the compensation function. At least one of the object-side surface 122 and the image-side surface 124 of the second negative lens 120 is made aspheric.

The third positive meniscus lens 130 has a concave object-side surface 132 and a convex image-side surface 134. A predetermined distance D23 is maintained between the concave image-side surface 124 of the second negative lens 120 and the concave object-side surface 132 of the third positive meniscus lens 130, so that the image height can be increased to a sufficient value and the angle of light rays can be adjusted as well. The third positive meniscus lens 130 has at least one aspheric surface.

The fourth negative lens 140 also has at least one aspheric surface that is formed with a reflection point 1420 within the effective diameter range where the orientation of the curvature changes. The main function of the fourth negative lens 140 is to correct the chief ray angle (CRA) and off-axis aberrations.

To reduce the overall length of the fixed-focus lens system 100 while ensuring high image quality and sufficient image height, the fixed-focus lens system 100 satisfies the following condition (1):

1<f12/f<2.2 (1)

where f represents the effective focal length of the fixed-focus lens system 100, and f12 represents the combined focal length of the first positive lens 110 and the second negative lens 120. When the value of f12/f exceeds the upper limit 2.2, the overall length of the fixed-focus lens system 100 will be too long to meet the compactness requirement. When the value of f12/f is smaller than the lower limit 1, the image height may be insufficient for a high resolution image sensor.

The fixed-focus lens system 100 further satisfies the following condition (2):

0.1<R_{S32}/f<0.3 (2)

where f represents the effective focal length of the fixed-focus lens system 100, and R_{S32} represents the curvature radius of the image-side surface 134 of the third positive meniscus lens 130. When the value of R_{S32}/f exceeds the upper limit 0.3, it becomes difficult to correct the coma aberration. When the value of R_{S32}/f is smaller than the lower limit 0.1, the astigmatism aberration remarkably increases.

In addition, the distance D23 between the third positive meniscus lens 130 and the second negative lens 120 satisfies the following condition (3):

0.07<D23/L<2.8 (3)

where L represents the overall length of the fixed-focus lens system 100 measured from a front vertex of the first positive lens 110 to a rear vertex of the fourth negative lens 140. When the value of D23/L exceeds the upper limit 2.8, the overall length of the fixed-focus lens system 100 will be too long to meet the compactness requirement. When the value of D23/L is smaller than the lower limit 0.07, the image height may be insufficient for a high resolution image sensor.

In addition, the fixed-focus lens system 100 further includes an aperture stop 190 disposed on the object side of the first positive lens 110. By arranging the aperture stop 190 before the first positive lens 110, the exit pupil position is located as near to the object side as possible and a satisfying telecentricity of the fixed-focus lens system 100 also can be obtained.

The fixed-focus lens system 100 further includes an optical filter or a cover glass 150 disposed on the image side of the fourth negative lens 140. Preferably, the second negative lens 120, the third positive meniscus lens 130 and the fourth negative lens 140 of the fixed-focus lens system 100 are all made of plastics.

To show the practicability and advantages of the fixed-focus lens system 100, three numerical embodiments are provided herein with associated optical parameters and optical characteristics graphs thereof.

### Numerical Embodiment 1

The optical parameters of the first positive lens 110, the second negative lens 120, the third positive meniscus lens 130 and the fourth negative lens 140 according to the Numerical Embodiment 1 are listed in Table 1 as provided below. In addition, in Table 1, “STO” represents the aperture stop 190, “FS” represents the optical filter 150 and “IMA” represents the image plane. In Numerical Embodiment 1, the object-side surface 122 of the second negative lens 120 has a positive curvature.

TABLE 1

| | | | | Abbe |
|---|---|---|---|---|
| | Radius | Thickness or | Refractive Index | Number |
| Surface | Curvature (mm) | Distance (mm) | (Nd) | (Vd) |
| STO | Infinity | 0.0 | | |
| S112 | 4.28 | 2.26 | 1.620 | 60.3 |
| S114 | −12.3 | 0.25 | | |
| S122 | 1346.8 | 0.53 | 1.585 | 29.9 |
| S124 | 3.654 | 1.42 | | |
| S132 | −7.733 | 1.737 | 1.5219 | 56.2 |
| S134 | −3.044 | 0.472 | | |
| S142 | −3.698 | 1.12 | 1.5219 | 56.2 |
| S144 | 2.297 | 2.28 | | |
| FS | Infinity | 0.8 | 1.5139 | 64.1 |
| IMA | Infinity | | | |

Other optical characteristics of Numerical Embodiment 1 of the fixed-focus lens system 100 are further listed in Table 2.

TABLE 2

| | |
|---|---|
| Effective Focal Length | 8.32 mm |
| Filed of View | 59.4° |
| F number | 3.0 |
| Image Circle | 9.5 mm |
| Maximum Chief Ray Angle | 17.15° |
| f12/f | 1.608 |
| R_{S32}/f | 0.17 |
| D23/L | 0.13 |
| f1 | 5.4 mm |
| f2 | −6.24 mm |
| f12 | 13.38 mm |
| D23 | 1.42 mm |
| L | 7.79 mm |

It can be found in Table 2 that the value of f12/f is 1.608, the value of R_{S32}/f is 0.17 and the value of D23/L is 0.13. All these values are within respective ranges provided by conditions (1), (2) and (3).

Further, in Numerical Embodiment 1, the second negative lens 120, the third positive meniscus lens 130 and the fourth negative lens 140 are all aspheric lenses each having both opposite surfaces thereof to be aspheric surfaces. These aspheric surfaces are expressed by the following formula:

$$z = \frac{{ch}^{2}}{1 + {[ 1 - ( k + 1 ) {c}^{2} {h}^{2} ]}^{1 / 2}} + A {h}^{4} + {Bh}^{6} + {Ch}^{8} + {Dh}^{10} + {Eh}^{12} + {Fh}^{14} + {Gh}^{16}$$

where z is Sag value along the optical axis, c is the base curvature (1/radius) of the surface, h is the height of a point on the aspheric surface with respect to the optical axis, k is the conic coefficient, and A, B, C, D, E, F, and G are the 4th-order, 6th-order, 8th-order, 10th-order, 12th-order, 14th-order and 16th-order aspheric coefficients, respectively.

Aspheric coefficients for the aspheric surfaces of the second negative lens 120, the third positive meniscus lens 130 and the fourth negative lens 140 are provided in Tables 3 and 4.

TABLE 3

| Surface | K | A | B | C |
|---|---|---|---|---|
| S122 | 0.00 | −2.0415 × 10⁻² | 5.093 × 10⁻³ | −7.68 × |
| | | | | 10⁻⁴ |
| S124 | 1.05469 | −2.3468 × 10⁻² | 4.881 × 10⁻³ | −8.68 × |
| | | | | 10⁻⁴ |
| S132 | −6.28946 | −3.692 × 10⁻³ | −9.3593 × 10⁻⁴ | −6.21807 × |
| | | | | 10⁻⁴ |
| S134 | −1.0 | −7.617 × 10⁻³ | 1.1245 × 10⁻³ | 3.2303 × |
| | | | | 10⁻⁴ |
| S142 | −5.52309 | −1.7265 × 10⁻² | 2.5226 × 10⁻⁴ | 1.90735 × |
| | | | | 10⁻⁴ |
| S144 | −1.0 | −3.6294 × 10⁻² | 3.846 × 10⁻³ | −3.63 × |
| | | | | 10⁻⁴ |

TABLE 4

| Surface | D | E | F | G |
|---|---|---|---|---|
| S122 | −1.2352 × 10⁻⁶ | −1.3169 × 10⁻⁵ | 0.00 | 0.00 |
| S124 | 5.0599 × 10⁻⁵ | 0.00 | 0.00 | 0.00 |
| S132 | 2.11386 × 10⁻⁴ | −1.9153 × 10⁻⁵ | 0.00 | 0.00 |
| S134 | 3.6903 × 10⁻⁵ | −9.5796 × 10⁻⁷ | 0.00 | 0.00 |
| S142 | −1.4173 × 10⁻⁵ | −2.8149 × 10⁻⁷ | 5.629 × 10⁻⁸ | −1.4373 × |
| | | | | 10⁻⁹ |
| S144 | 2.64 × 10⁻⁵ | −1.2899 × 10⁻⁶ | 3.4854 × 10⁻⁸ | −3.8388 × |
| | | | | 10⁻¹⁰ |

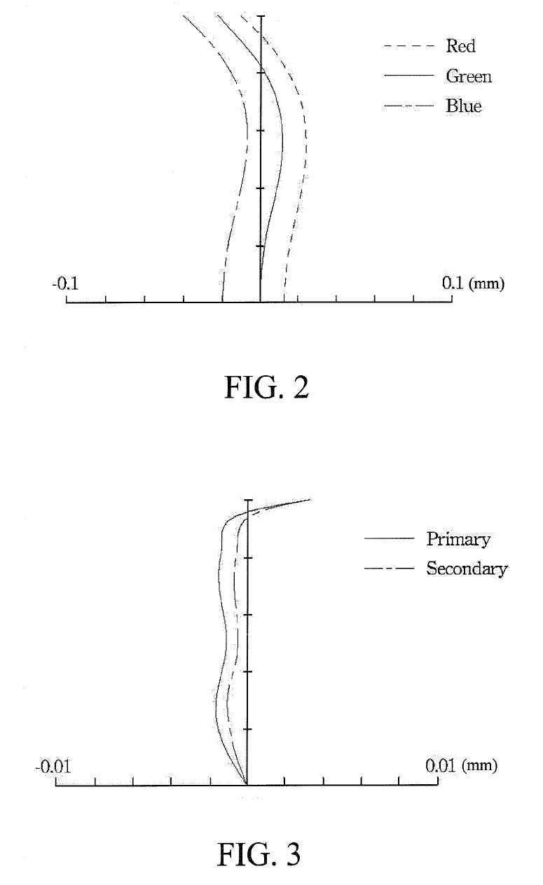

FIG. 2 is a graph showing longitudinal spherical aberration of Numerical Embodiment 1 of the fixed-focus lens system 100, wherein the three curves are respectively longitudinal spherical aberration curves for red, green and blue lights. It can be seen from FIG. 2 that the fixed-focus lens system 100 has a good imaging effect. FIG. 3 is a graph showing lateral chromatic aberration of Numerical Embodiment 1 of the fixed-focus lens system 100. Both the primary and secondary lateral chromatic aberration curves in FIG. 3 illustrate that the lateral chromatic aberrations of the fixed-focus lens system 100 are well corrected in Numerical Embodiment 1.

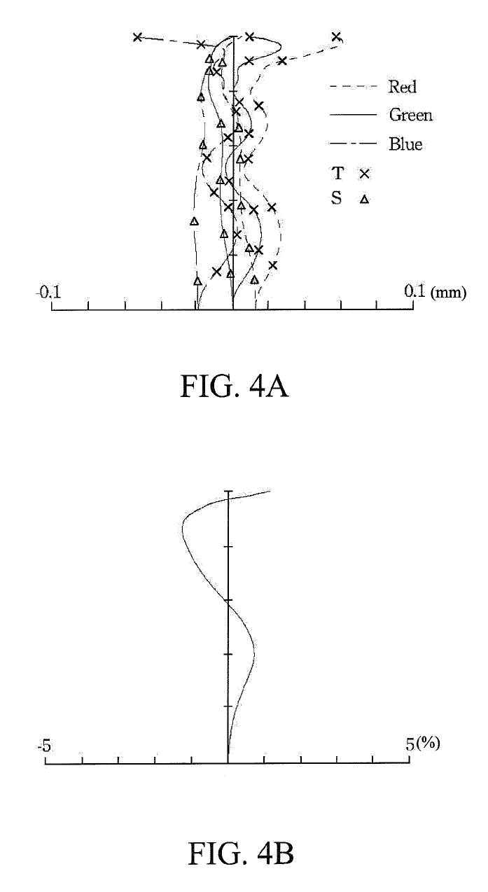

FIG. 4A is a graph showing field curvature of Numerical Embodiment 1 of the fixed-focus lens system 100. In FIG. 4A, “T” represents tangential rays of the incident light, and “S” represents sagittal rays of the incident light. The abscissa indicates the distance between an imaging point and an ideal image plane, and the ordinate indicates the ideal image height or incident angle. FIG. 4B is a graph showing distortion of Numerical Embodiment 1 of the fixed-focus lens system 100, wherein abscissa indicates the percentage difference between the imaging point and the ideal image point, and the ordinate indicates the ideal image height or incident angle. As shown in FIGS. 4A and 4B, the field curvature and distortion of Numerical Embodiment 1 of the fixed-focus lens system 100 are both within an acceptable level.

### Numerical Embodiment 2

The optical parameters of the first positive lens 110, the second negative lens 120, the third positive meniscus lens 130 and the fourth negative lens 140 according to the Numerical Embodiment 2 are listed in Table 5 as provided below. In addition, in Table 5, “STO” represents the aperture stop 190, “FS” represents the optical filter 150 and “IMA” represents the image plane. In Numerical Embodiment 2, the object-side surface 122 of the second negative lens 120 has a negative curvature.

TABLE 5

| | | | | Abbe |
|---|---|---|---|---|
| | Radius | Thickness or | Refractive Index | Number |
| Surface | Curvature (mm) | Distance (mm) | (Nd) | (Vd) |
| STO | Infinity | 0.0 | | |
| S112 | 4.459 | 2.4 | 1.620 | 60.3 |
| S114 | −10.534 | 0.25 | | |
| S122 | −76.09 | 0.52 | 1.585 | 29.9 |
| S124 | 3.766 | 1.29 | | |
| S132 | −9.157 | 1.976 | 1.5149 | 57.2 |
| S134 | −3.176 | 0.599 | | |
| S142 | 3.687 | 1.157 | 1.5219 | 56.2 |
| S144 | 2.292 | 2.109 | | |
| FS | Infinity | 0.8 | 1.5139 | 64.1 |
| IMA | Infinity | | | |

Other optical characteristics of Numerical Embodiment 2 of the fixed-focus lens system 100 are further listed in Table 6.

TABLE 6

| | |
|---|---|
| Effective Focal Length | 8.27 mm |
| Filed of View | 58.1° |
| F number | 3.0 |
| Image Circle | 9.2 mm |
| Maximum Chief Ray Angle | 17.2° |
| f12/f | 1.654 |
| R_{S32}/f | 0.156 |
| D23/L | 0.116 |
| f1 | 5.38 mm |
| f2 | −6.11 mm |
| f12 | 13.68 mm |
| D23 | 1.29 mm |
| L | 8.19 mm |

It can be found in Table 6 that the value of f12/f is 1.654, the value of R_{S32}/f is 0.156 and the value of D23/L is 0.116. All these values are within respective ranges provided by conditions (1), (2) and (3).

Further, in Numerical Embodiment 2, the second negative lens 120, the third positive meniscus lens 130 and the fourth negative lens 140 are all aspheric lenses each having both opposite surfaces thereof to be aspheric surfaces. Aspheric coefficients for the aspheric surfaces of the second negative lens 120, the third positive meniscus lens 130 and the fourth negative lens 140 are provided in Tables 7 and 8.

TABLE 7

| Surface | K | A | B | C |
|---|---|---|---|---|
| S122 | 0.00 | −2.2829 × 10⁻² | 5.466 × 10⁻³ | −3.62 × 10⁻⁴ |
| S124 | 0.08205 | −2.5045 × 10⁻² | 6.522 × 10⁻³ | −9.86 × 10⁻⁴ |
| S132 | 4.188545 | −5.252 × 10⁻³ | −5.44 × 10⁻⁴ | −7.18 × 10⁻⁴ |
| S134 | −1.0 | −1.2813 × 10⁻² | 2.125 × 10⁻³ | −3.9019 × 10⁻⁴ |
| S142 | −6.583482 | −1.8991 × 10⁻² | 5.1929 × 10⁻⁴ | 1.86322 × 10⁻⁴ |
| S144 | −1.0 | −3.6018 × 10⁻² | 3.815 × 10⁻³ | −3.56877 × |
| | | | | 10⁻⁴ |

TABLE 8

| Surface | D | E | F | G |
|---|---|---|---|---|
| S122 | −1.81 × 10⁻⁴ | 3.0129 × 10⁻⁵ | 0.00 | 0.00 |
| S124 | 5.9166 × 10⁻⁵ | 0.00 | 0.00 | 0.00 |
| S132 | 2.48 × 10⁻⁴ | −1.8339 × 10⁻⁵ | 0.00 | 0.00 |
| S134 | 2.9528 × 10⁻⁵ | 4.0179 × 10⁻⁷ | 0.00 | 0.00 |
| S142 | −1.4724 × 10⁻⁵ | −2.9078 × 10⁻⁷ | 5.681 × 10⁻⁸ | −1.3707 × |
| | | | | 10⁻⁹ |
| S144 | 2.6172 × 10⁻⁵ | −1.3002 × 10⁻⁶ | 3.5111 × 10⁻⁸ | −3.7174 × |
| | | | | 10⁻¹⁰ |

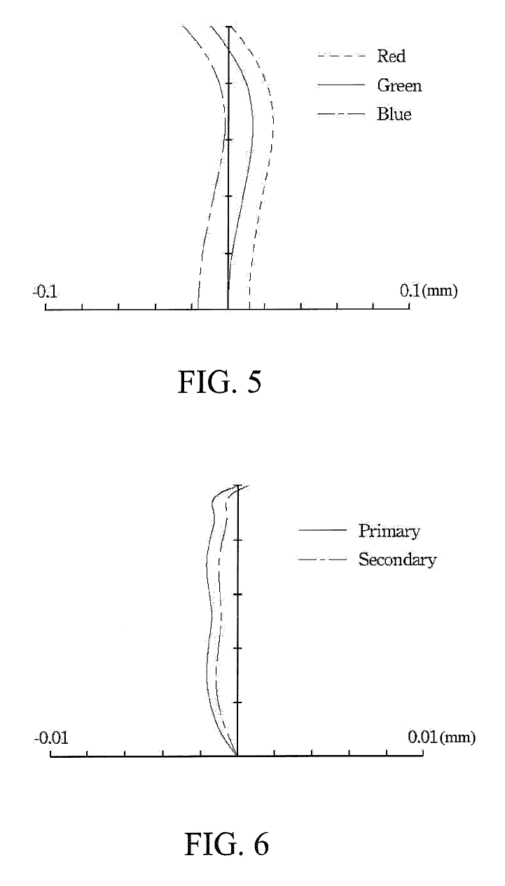

FIG. 5 is a graph showing longitudinal spherical aberration of Numerical Embodiment 2 of the fixed-focus lens system 100, wherein the three curves are respectively longitudinal spherical aberration curves for red, green and blue lights. It can be seen from FIG. 5 that the fixed-focus lens system 100 has a good imaging effect. FIG. 6 is a graph showing lateral chromatic aberration of Numerical Embodiment 2 of the fixed-focus lens system 100. Both the primary and secondary lateral chromatic aberration curves in FIG. 6 illustrate that the lateral chromatic aberrations of the fixed-focus lens system 100 are well corrected in Numerical Embodiment 2.

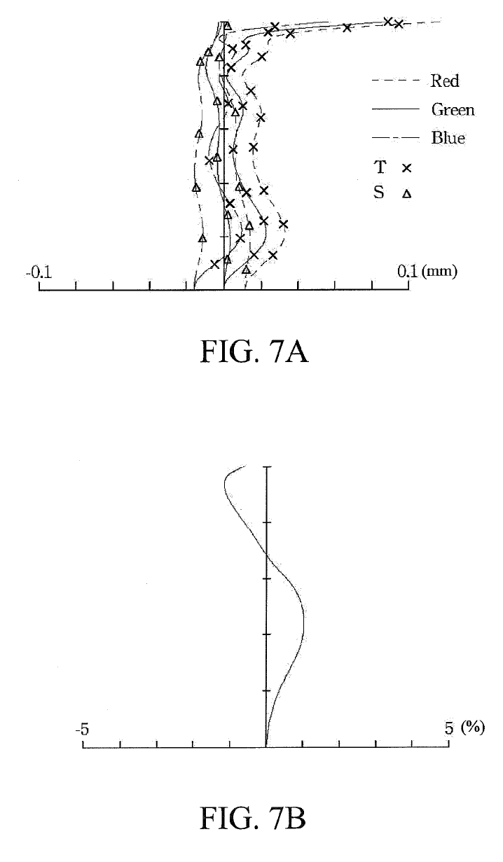

FIG. 7A is a graph showing field curvature of Numerical Embodiment 2 of the fixed-focus lens system 100. In FIG. 7A, “T” represents tangential rays of the incident light, and “S” represents sagittal rays of the incident light. The abscissa indicates the distance between an imaging point and an ideal image plane, and the ordinate indicates the ideal image height or incident angle. FIG. 7B is a graph showing distortion of Numerical Embodiment 2 of the fixed-focus lens system 100, wherein abscissa indicates the percentage difference between the imaging point and the ideal image point, and the ordinate indicates the ideal image height or incident angle. As shown by FIGS. 7A and 7B, the field curvature and distortion of Numerical Embodiment 2 of the fixed-focus lens system 100 are both within an acceptable level.

### Numerical Embodiment 3

The optical parameters of the first positive lens 110, the second negative lens 120, the third positive meniscus lens 130 and the fourth negative lens 140 according to the Numerical Embodiment 3 are listed in Table 9 as provided below. In addition, in Table 9, “STO” represents the aperture stop 190, “FS” represents the optical filter 150 and “IMA” represents the image plane. In Numerical Embodiment 3, the object-side surface 122 of the second negative lens 120 has a negative curvature much smaller than that for Numerical Embodiment 2.

TABLE 9

| | | | | Abbe |
|---|---|---|---|---|
| | Radius | Thickness or | Refractive Index | Number |
| Surface | Curvature (mm) | Distance (mm) | (Nd) | (Vd) |
| STO | Infinity | 0.0 | | |
| S112 | 4.353 | 2.4 | 1.620 | 60.3 |
| S114 | −13.064 | 0.25 | | |
| S122 | −2009.8 | 0.52 | 1.585 | 29.9 |
| S124 | 3.779 | 1.4 | | |
| S132 | −8.227 | 1.735 | 1.5146 | 57.2 |
| S134 | −3.115 | 0.404 | | |
| S142 | 3.4 | 1.115 | 1.5219 | 56.2 |
| S144 | 2.212 | 2.29 | | |
| FS | Infinity | 0.8 | 1.5139 | 64.1 |
| IMA | Infinity | | | |

Other optical characteristics of Numerical Embodiment 3 of the fixed-focus lens system 100 are further listed in Table 10.

TABLE 10

| | |
|---|---|
| Effective Focal Length | 8.27 mm |
| Filed of View | 59.4° |
| F number | 3.0 |
| Image Circle | 9.7 mm |
| Maximum Chief Ray Angle | 17.4° |
| f12/f | 1.642 |
| R_{S32}/f | 0.17 |
| D23/L | 0.128 |
| f1 | 5.56 mm |
| f2 | −6.44 mm |
| f12 | 13.58 mm |
| D23 | 1.4 mm |
| L | 7.82 mm |

It can be found in Table 10 that the value of f12/f is 1.642, the value of R_{S32}/f is 0.17 and the value of D23/L is 0.128. All these values are within respective ranges provided by conditions (1), (2) and (3).

Further, in Numerical Embodiment 3, the second negative lens 120, the third positive meniscus lens 130 and the fourth negative lens 140 are all aspheric lenses each having both opposite surfaces thereof to be aspheric surfaces. Aspheric coefficients for the aspheric surfaces of the second negative lens 120, the third positive meniscus lens 130 and the fourth negative lens 140 are provided in Tables 11 and 12.

TABLE 11

| Surface | K | A | B | C |
|---|---|---|---|---|
| S122 | 0.00 | −2.0941 × 10⁻² | 5.259 × 10⁻³ | −5.5914 × 10⁻⁴ |
| S124 | 0.568352 | −2.2945 × 10⁻² | 5.563 × 10⁻³ | −9.03594 × |
| | | | | 0⁻⁴ |
| S132 | −1.399136 | −3.841 × 10⁻³ | −6.4377 × 10⁻⁴ | −8.1235 × 10⁻⁴ |
| S134 | −1.0 | −1.2156 × 10⁻² | 2.071 × 10⁻³ | −4.0536 × 10⁻⁴ |
| S142 | −5.173745 | −1.8991 × 10⁻² | 5.3056 × 10⁻⁴ | 1.8685 × |
| | | | | 10⁻⁴ |
| S144 | −1.0 | −3.7096 × 10⁻² | 3.871 × 10⁻³ | −3.5753 × 10⁻⁴ |

TABLE 12

| Surface | D | E | F | G |
|---|---|---|---|---|
| S122 | −9.0454 × 10⁻⁵ | 2.1284 × 10⁻⁵ | 0.00 | 0.00 |
| S124 | 5.8308 × 10⁻⁵ | 0.00 | 0.00 | 0.00 |
| S132 | 2.33826 × 10⁻⁴ | −1.7735 × 10⁻⁵ | 0.00 | 0.00 |
| S134 | 2.8196 × 10⁻⁵ | 4.0885 × 10⁻⁷ | 0.00 | 0.00 |
| S142 | −1.4718 × 10⁻⁵ | −2.9093 × 10⁻⁷ | 5.6778 × 10⁻⁸ | −1.3908 × |
| | | | | 10⁻⁹ |
| S144 | 2.619 × 10⁻⁵ | −1.3008 × 10⁻⁶ | 3.5005 × 10⁻⁸ | −3.7346 × |
| | | | | 10⁻¹⁰ |

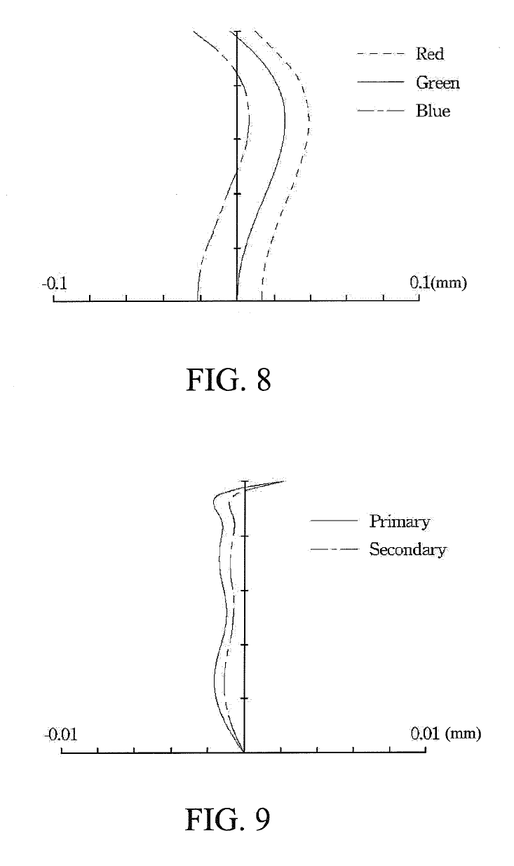

FIG. 8 is a graph showing longitudinal spherical aberration of Numerical Embodiment 3 of the fixed-focus lens system 100, wherein the three curves are respectively longitudinal spherical aberration curves for red, green and blue lights. It can be seen from FIG. 8 that the fixed-focus lens system 100 has a good imaging effect. FIG. 9 is a graph showing lateral chromatic aberration of Numerical Embodiment 3 of the fixed-focus lens system 100. Both the primary and secondary lateral chromatic aberration curves in FIG. 9 illustrate that the lateral chromatic aberrations of the fixed-focus lens system 100 are well corrected in Numerical Embodiment 3.

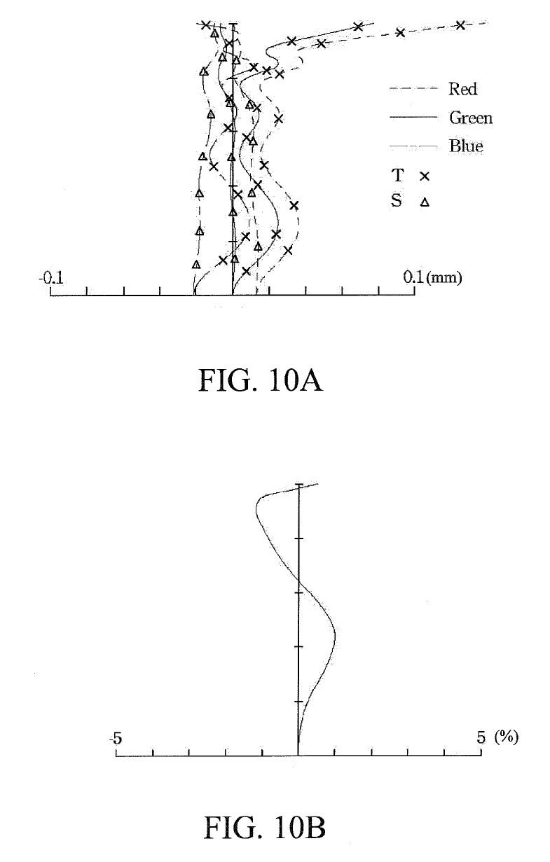

FIG. 10A is a graph showing field curvature of Numerical Embodiment 3 of the fixed-focus lens system 100. In FIG. 10A, “T” represents tangential rays of the incident light, and “S” represents sagittal rays of the incident light. The abscissa indicates the distance between an imaging point and an ideal image plane, and the ordinate indicates the ideal image height or incident angle. FIG. 10B is a graph showing distortion of Numerical Embodiment 3 of the fixed-focus lens system 100, wherein abscissa indicates the percentage difference between the imaging point and the ideal image point, and the ordinate indicates the ideal image height or incident angle. As shown by FIGS. 10A and 10B, the field curvature and distortion of Numerical Embodiment 3 of the fixed-focus lens system 100 are both within an acceptable level.

By adjusting related optical parameters, the overall length of the fixed-focus lens system 100 according to Numerical Embodiment 3 is reduced relative to that of Numerical Embodiment 2. The overall length of Numerical Embodiment 3 is thus approximate to that of Numerical Embodiment 1, whereby a compact fixed-focus lens system is obtained.

As described above, the majority of the component lenses of the fixed-focus lens system of the present invention are plastic aspheric lenses. This significantly reduces the tolerance sensitivity during manufacture, and thus reduces the production cost of the fixed-focus lens system. By adjusting related optical parameters to effectively correct various aberrations, high image quality is also provided by the fixed-focus lens system. In addition, sufficient image height is obtained, the chief ray angle is reduced and the image circle is larger than 9 mm in diameter, which is desired for a high-resolution image sensor. In all the numerical embodiments, the overall length of the fixed-focus lens system is controlled to be substantially smaller than 8 mm, which contributes to the compactness of the fixed-focus lens system.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A fixed-focus lens system comprising:
a positive collecting lens for collecting light from an object to be imaged;
a positive meniscus lens disposed on an image side of the positive collecting lens, the positive meniscus lens having a concave surface on an object side and a convex surface on the image side, at least one of the concave and convex surfaces being aspheric;
a first negative lens disposed between the positive collecting lens and the positive meniscus lens, the first negative lens having an object-side surface with positive or negative curvature and an image-side surface concave toward the object side, at least one of the object-side surface and the image-side surface being aspheric;
a second negative lens disposed on the image side of the positive meniscus lens, the second negative lens having increasing negative refractive power from an optical axis of the fixed-focus lens system toward a periphery; and
an aperture stop disposed on the object side of the positive collecting lens;
wherein the fixed-focus lens system satisfies the following condition:
0.1<R_{S32}/f<0.3
where f represents the effective focal length of the fixed-focus lens system, and R_{S32} represents the curvature radius of the image-side surface of the positive meniscus lens.

2. The fixed-focus lens system as claimed in claim 1, wherein the positive collecting lens has a convex surface on the object side.

3. The fixed-focus lens system as claimed in claim 1, wherein the second negative lens has at least one aspheric surface formed with an inflection point.

4. The fixed-focus lens system as claimed in claim 1, satisfying the following condition:
1<f12/f<2.2
where f represents the effective focal length of the fixed-focus lens system, and f12 represents the combined focal length of the positive collecting lens and the first negative lens.

5. The fixed-focus lens system as claimed in claim 1, satisfying the following condition:
0.07<D23/L<2.8
where L represents the overall length of the fixed-focus lens system, and D23 represents a distance between the first negative lens and the positive meniscus lens.

6. The fixed-focus lens system as claimed in claim 1 further comprising an optical filter disposed on the image side of the second negative lens.

7. The fixed-focus lens system as claimed in claim 1, wherein the positive meniscus lens, the first negative lens and the second negative lens are made of plastics.

8. A fixed-focus lens system comprising, in order from an object side to an image side along an optical axis thereof:
an aperture stop;
a first positive lens;
a second negative lens;
a third positive meniscus lens; and
a fourth negative lens having increasingly negative refractive power from the optical axis toward the periphery;
wherein the fixed-focus lens system satisfies the following condition:
0.1<R_{S32}/f<0.3
where f represents the effective focal length of the fixed-focus lens system, and R_{S32} represents the curvature radius of an image-side surface of the third positive meniscus lens.

9. The fixed-focus lens system as claimed in claim 8, wherein the first positive lens has a convex surface on the object side.

10. The fixed-focus lens system as claimed in claim 8, wherein the second negative lens has an object-side surface with positive or negative curvature and an image-side surface concave toward the object side, at least one of the object-side surface and the image-side surface being aspheric.

11. The fixed-focus lens system as claimed in claim 8, wherein the third positive meniscus lens has a concave surface on the object side and a convex surface on the image side, at least one of the concave and convex surfaces being aspheric.

12. The fixed-focus lens system as claimed in claim 8, wherein the fourth negative lens has at least one aspheric surface formed with an inflection point.

13. The fixed-focus lens system as claimed in claim 8, satisfying the following condition:
1<f12/f<2.2
where f represents the effective focal length of the fixed-focus lens system, and f12 represents the combined focal length of the first positive lens and the second negative lens.

14. The fixed-focus lens system as claimed in claim 8, satisfying the following condition:
0.07<D23/L<2.8
where L represents the overall length of the fixed-focus lens system, and D23 represents a distance between the second negative lens and the third positive meniscus lens.

15. The fixed-focus lens system as claimed in claim 8 further comprising an optical filter disposed on the image side of the fourth negative lens.

16. The fixed-focus lens system as claimed in claim 8, wherein the second negative lens, the third positive meniscus lens and the fourth negative lens are made of plastic.
